(19) United States
(12) Patent Application Publication
(10) Pub. No.: US 2016/0235627 A1
(43) Pub. Date: Aug. 18, 2016

(54) DIVIDED PACKET, METHOD OF MANUFACTURING DIVIDED PACKET, AND DEVICE FOR MANUFACTURING DIVIDED PACKET

(71) Applicant: MORIMOTO-PHARMA CO., LTD., Osaka (JP)

(72) Inventors: Shuji MORIMOTO, Osaka (JP); Masaho MIKAMI, Osaka (JP); Masao NOZAKI, Osaka (JP); Hiroshi YAMAUCHI, Osaka (JP)

(73) Assignee: MORIMOTO-PHARMA CO., LTD.

(21) Appl. No.: 15/140,493

(22) Filed: Apr. 28, 2016

Related U.S. Application Data
(63) Continuation of application No. PCT/JP2013/079214, filed on Oct. 29, 2013.

(51) Int. Cl. A61J 1/20; B65B 29/10; A61J 1/03

(52) U.S. Cl. CPC A61J 1/2093; A61J 1/03; B65B 29/10

(57) ABSTRACT

A divided packet (10) has a packaging body (2), a drug (3), and a divided bag (4). The packaging body (2) seals in a swallowing aid substance (1). The drug (3) is disposed on the exterior of the packaging body (2). The divided bag (4) seals in the drug (3) and the packaging body (2) in which the swallowing aid substance (1) is sealed. The packaging body (2) and the drug (3) are sealed in the divided bag (4). Due to this configuration, using a simple method it is possible to provide the divided packet (10) with which the swallowing of the drug (3) can be aided.

### CROSS-REFERENCES TO RELATED APPLICATIONS

This application claims the benefit of priority and is a Continuation application of the prior International Patent Application No. PCT/JP2013/079214, with an international filing date of Oct. 29, 2013, which designated the United States, the entire disclosures of all applications are expressly incorporated by reference in their entirety herein.

### BACKGROUND OF THE INVENTION

1. Field of the Invention

This invention is related to the divided packet, method of manufacturing divided packet, and device for manufacturing divided packet, and more specifically, related to the divided packet, method of manufacturing divided packet, and device for manufacturing divided packet having the packaging body sealed with the swallowing aid substance.

2. Description of Related Art

The method of administering the drug by using a swallowing aid substance such as jelly to easily swallow the drug was proposed. For example, in the Japanese Published Unexamined Application No. 2011-200261 (Patent document 1), a powder accommodating chamber that accommodates powder or granules, a swallowing aid substance accommodating chamber that accommodates a swallowing aid substance such as jelly, and an administering item accommodating chamber formed with the feed way that mutually connects with the powder accommodating chamber and the swallowing aid substance accommodating chamber were mentioned. The concerned feed way was sealed by an easy-to-open section that can be opened. According to this administering item accommodating chamber, the easy-to-open section is unsealed by pressing the swallowing aid substance accommodating chamber, the jelly is guided to the powder accommodating chamber, and the powder or granules administering item is wrapped. The powder or granules administering item wrapped in the jelly is taken out of the concerned administering item accommodating chamber and administered. Hence, the senior citizens who are not good at swallowing drugs can also administer the drug easily, if they have the above-mentioned administering item accommodating chamber.

In the Japanese Published Unexamined Application No. 2011-206150 (Patent document 2), a drug adjustment container to dissolve the drugs to the dissolved substance was described. According to the concerned drug adjustment container, for example, the accommodation bag that accommodates the dissolved substance of the sterilized purified water is provided inside a drug adjustment container. When adjusting the drug, the drug is inserted into the drug chamber after removing the stopcock from the drug passage tube. The dissolved substance is filled in the drug container inserted with the drug, and the drug is dissolved in the dissolved substance. While administering, a three-way valve is fixed in the drug passage tube, and the dissolved substance is injected into patient's body through the three-way valve.

In the Japanese Published Unexamined Application No. 2003-677 (Patent document 3), a divided bag that was divided for each dosage with the drug adjusted based on the Doctor's prescription was described. According to this concerned divided bag, minute scratches were formed in the medicine wrapping paper made from polyethylene terephthalate (PET) etc. Hence, even the senior citizens or the children, can open the divided bag with bare hands easily.
Patent document 1: Japanese Published Unexamined Application No. 2011-200261
Patent document 2: Japanese Published Unexamined Application No. 2011-206150
Patent document 3: Japanese Published Unexamined Application No. 2003-677

### BRIEF SUMMARY OF THE INVENTION

However, according to the administering item accommodating chamber mentioned in the Japanese Published Unexamined Application No. 2011-200261, it is necessary to use an accommodating chamber of special shape with the powder accommodating chamber and a swallowing aid substance accommodating chamber sealed with the easy-to-open section. According to the drug adjustment chamber mentioned in the Japanese Published Unexamined Application No. 2011-206150, it is necessary to insert the drug in the drug chamber after removing the stopcock from the drug passage tube, and then cock the drug passage tube again, while dissolving the drug in the dissolved substance. Hence, the method of dissolving the drug to the dissolved substance becomes complex. According to the Japanese Published Unexamined Application No. 2003-677, it is necessary to open the divided bag, take out the drug, and prepare the swallowing aid substance separately.

This invention was performed considering the above-mentioned problems, and the purpose is to provide a divided packet, a method of manufacturing the divided packet, and a device for manufacturing divided packet that can aid in swallowing the drug, using a simple method.

The divided packet related to this invention is provided with the packaging body, drug, and divided bag. The jelly that is the swallowing aid substance is sealed in the packaging body. The drug is disposed on the exterior of the packaging body. The divided bag seals the packaging body sealed with the jelly and the drug. The packaging body and drug are sealed by the divided bag.

According to the divided packet of this invention, the packaging body sealed with the jelly and the drug are sealed by a commonly used divided packet. Hence, a divided packet that can aid in swallowing the drug by a simple method can be offered, without using the special form of administering item accommodating chamber. The jelly is sealed by the packaging body, and the packaging body is sealed by the divided bag. Hence, the deterioration of the jelly can be effectively controlled.

In the above-mentioned divided packet, the packaging body is constructed to enable the flow of the jelly from the inside of the packaging body, to the inside of the divided bag and external to the packaging body, due to an external pressure. As a result, the drug can be mixed by introducing the jelly inside the divided bag by a simple method.

In the above-mentioned divided packet, the packaging body contains the first seal that is heat sealed with an overlapped film, and extended in one direction. The jelly is constructed to enable the flow from the inside of the packaging body by destroying the first seal, to the inside of the divided bag and external to the packaging body. By forming the first seal, the load can be adjusted when inserting the jelly inside the divided bag.

In the above-mentioned divided packet, the packaging body also includes a second seal that is set on the side opposite to the direction where the jelly is disposed with respect to the said first seal and has higher seal strength than the first seal. The second seals are set in multiple numbers, so as to separate the flow when the jelly flows from the inside of the packaging body, to the inside of the divided bag and external to the packaging body; to have the distance between the first seals along the vertical direction where the first seal is extended; the size along direction where the first seal is extended is smaller than the size of the first seal; and to keep the space and adjoin along the direction where the first seal is extended. The multiple second seals are constructed to enable the smashing by passing the jelly that flows from the inside of the packaging body between the adjoining two second seals, when an external pressure is applied to the jelly. The jelly can be smashed to the size that is easy to swallow, because the jelly can be smashed by the second seal.

The method of manufacturing the divided packet of this invention is provided by the following processes. The divided bag that has the opening and provided with the drug and the packaging body sealed with the jelly in the inside is arranged. The packaging body sealed with the jelly and the drug is sealed by the divided bag. Here, the packaging body contains the above-mentioned first seal and the second seal.

According to the method of manufacturing the divided packet of this invention, the packaging body sealed with the jelly and the drug are sealed by the divided bag. As a result, a divided packet that can aid in swallowing the drug by a simple method, without using the special form of administering item accommodating chamber, can be manufactured. The jelly is sealed by the packaging body, and the packaging body is sealed by the divided bag. Hence, a divided packet that can effectively control the deterioration of the jelly can be manufactured. The packaging body contains the above-mentioned first seal and the second seal, and hence the divided packet that can introduce the jelly inside the divided bag and mix with the drug, and adjust the load when the jelly is introduced inside the divided bag, smash the jelly to the size that is easy to swallow by a simple method, can be manufactured.

In the method of manufacturing the above-mentioned divided packet, the process of preparing the divided bag provided with the packaging body and the drug in the inside includes a process of preparing the divided bag sealed with the drug, a process of opening the divided bag, and a process of providing the packaging body sealed with the jelly inside the unsealed divided bag. As a result, the divided packet that can aid in swallowing the drug can be manufactured, by unsealing the divided bag sealed with the drug, and by providing the packaging body sealed with the jelly inside the unsealed divided bag.

The device for manufacturing the divided packet of this invention is provided with the packaging body inserter and the divided bag sealer. The packaging body inserter is constructed to enable the provision of the packaging body sealed with the jelly, inside the divided bag that has the opening. The divided bag sealer is constructed to enable the sealing of divided bag by closing the opening of the divided bag provided inside the packaging body sealed with the jelly and the drug. Here, the packaging body contains the above-mentioned first seal and the second seal.

According to the device for manufacturing the divided packet of this invention, the packaging body inserter is constructed to enable the provision of the packaging body sealed with the jelly, inside the divided bag that has the opening. As a result, a manufacturing device that can manufacture the divided packet to aid in swallowing the drug by a simple method, without using the special form of administering item accommodating chamber can be provided. The jelly is sealed by the packaging body, and the packaging body is sealed by the divided bag. Hence, a manufacturing device that can manufacture the divided packet that can effectively control the deterioration of the jelly can be provided. The packaging body contains the above-mentioned first seal and the second seal, and hence a manufacturing device that can manufacture the divided packet that can introduce the jelly inside the divided bag and mix with the drug, and adjust the load when the jelly is introduced inside the divided bag, smash the jelly to the size that is easy to swallow by a simple method, can be provided.

The manufacturing device of the above-mentioned divided packet is further provided with a divided bag unsealer that is constructed to enable the unsealing of the divided bag sealed with the drug. A manufacturing device that can manufacture the divided packet to aid in swallowing the drug, by unsealing the divided bag sealed with the drug, and by providing the packaging body sealed with the jelly inside the unsealed divided bag can be provided.

According to this invention, a divided packet that can aid in swallowing the drug by a simple method, method of manufacturing the divided packet, and device for manufacturing the divided packet, can be provided.

### BRIEF DESCRIPTION OF THE DRAWINGS

FIG. 1 Perspective schematic view showing the construction of the divided packet related to embodiment 1 of this invention.

FIG. 2 Sectional schematic view in the area II-II of FIG. 1.

FIG. 3 Sectional schematic view in the area of FIG. 1.

FIG. 4 Sectional schematic view in the area IV-IV of FIG. 1.

FIG. 5 Sectional schematic view showing the first use situation of the divided packet related to embodiment 1 of this invention.

FIG. 6 Sectional schematic view showing the second use situation of the divided packet related to embodiment 1 of this invention.

FIG. 7 Plan schematic view showing the second use situation of the divided packet related to embodiment 1 of this invention.

FIG. 8 Plan schematic view showing the third use situation of the divided packet related to embodiment 1 of this invention.

FIG. 9 Plan schematic view showing the alternative example of packaging body with the divided packet related to embodiment 1 of this invention.

FIG. 10 Sectional schematic view in the area X-X of illustration drawing 9.

FIG. 11 Side schematic view showing the construction of the manufacturing device of divided packet related to embodiment 1 of this invention.

FIG. 12 Top schematic view showing the construction of the manufacturing device of divided packet related to embodiment 1 of this invention.

FIG. 13 Top schematic view showing the construction of alternate example of the manufacturing device of divided packet related to embodiment 1 of this invention.

FIG. 14 Side schematic view showing the first example of the manufacturing method of divided packet related to embodiment 1 of this invention.

FIG. 15 Side schematic view showing the second example of the manufacturing method of divided packet related to embodiment 1 of this invention.

FIG. 16 Plan schematic view showing the construction of the first example of divided packet related to embodiment 2 of this invention.

FIG. 17 Plan schematic view showing the construction of the second example of divided packet related to embodiment 2 of this invention.

FIG. 18 Plan schematic view showing the construction of the divided packet related to embodiment 3 of this invention.

FIG. 19 Plan schematic view showing the construction of the divided packet related to embodiment 4 of this invention.

FIG. 20 Plan schematic view showing the drug administering end in unsealed condition of the divided packet related to embodiment 4 of this invention.

FIG. 21 Plan schematic view showing the construction of the divided packet related to embodiment 5 of this invention.

FIG. 22 Plan schematic view showing the drug administering end in unsealed condition of the divided packet related to embodiment 5 of this invention.

FIG. 23 Plan schematic view showing the construction of the divided packet related to embodiment 6 of this invention.

FIG. 24 Plan schematic view showing the construction of the divided packet related to embodiment 7 of this invention.

FIG. 25 Plan schematic view showing the construction of the divided packet related to embodiment 8 of this invention.

FIG. 26 Figure showing the relation between the load and slit width.

### DETAILED DESCRIPTION OF THE INVENTION

The following is the explanation of embodiment of this invention based on the drawing. However, in case of same or corresponding parts occurring in the following sections, same reference number is given to them, and the explanation is not repeated.

### Embodiment 1

First, the construction of the divided packet 10 related to embodiment 1 of this invention is explained.

With reference to FIG. 1, the divided packet 10 related to embodiment 1 mainly has the packaging body 2 sealed with the swallowing aid substance 1, drug 3, and divided bag 4.

The swallowing aid substance 1 is a material that can aid in swallowing the drug 3, for example, an edible jelly that can be orally administered. Preferably, the swallowing aid substance 1 is in gel state, and has the viscosity to the extent that it can stick to the drug 3, so as to wrap the drug 3. The swallowing aid substance 1, enters the mouth cavity by sticking to drug 3, so as to wrap the drug 3, and is carried to the stomach by passing through the throat and esophagus. Hence, it is preferable that the swallowing aid substance 1 has the viscosity to extent that it can smoothly pass each inner wall of the throat and esophagus. The swallowing aid substance 1 is a liquid, liquid or semi-solid, and preferably contains moisture. It is better that the swallowing aid substance 1 may be water. Preferably, for the swallowing aid substance 1, the viscosity and cohesive property is higher than water, and the adhesive property towards the drug 3 is high. The swallowing aid substance 1 may contain the material (For example, lactic acid bacterium etc.) that contains medicinal properties or active ingredient.

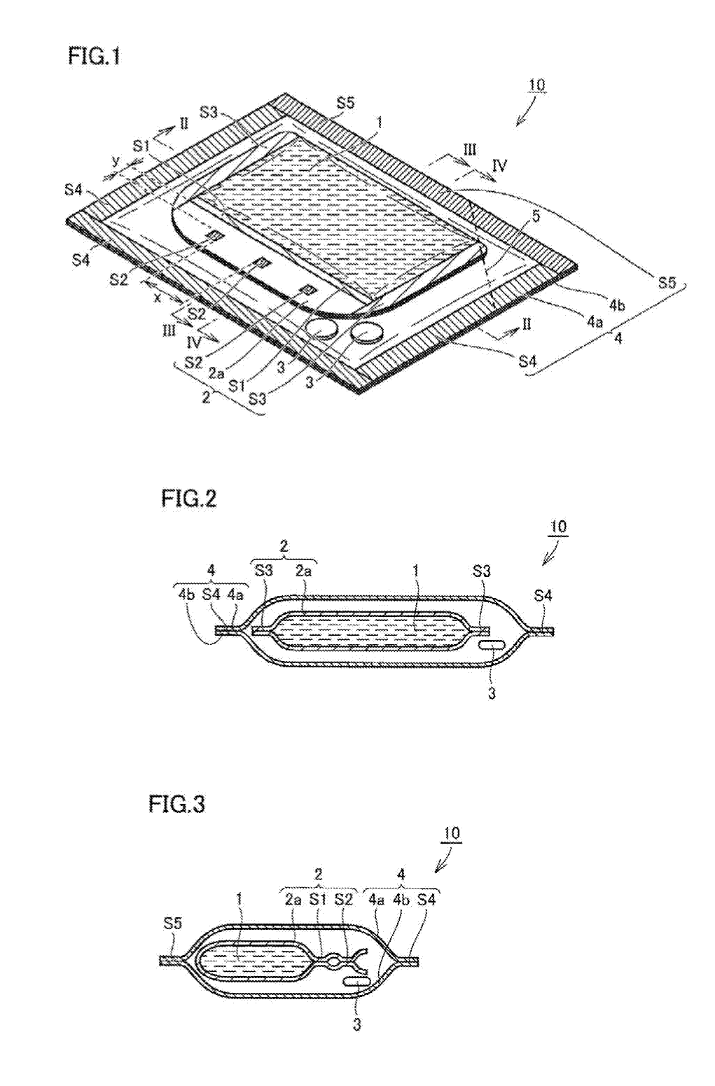

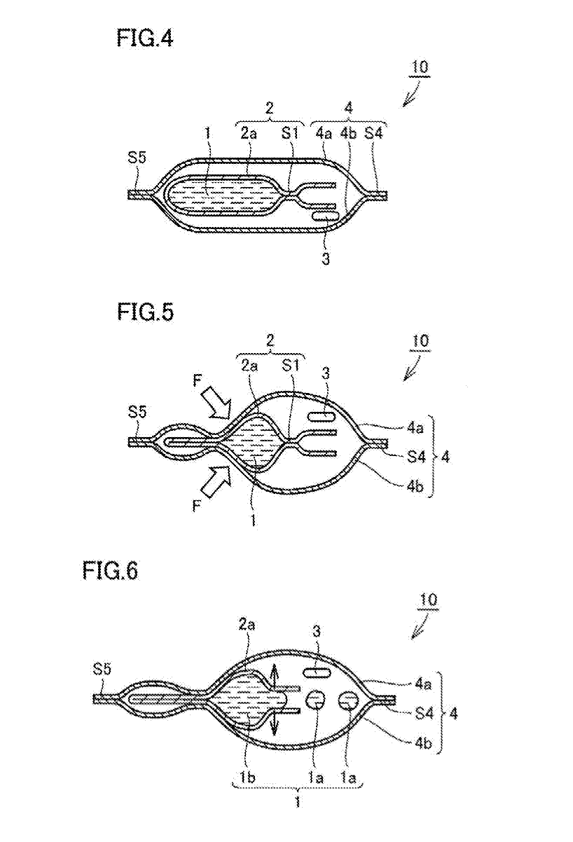

With reference to FIG. 2, the swallowing aid substance 1 is sealed in the packaging body 2. Preferably, the swallowing aid substance 1 is sealed in fluid-tight state in the packaging body 2. The film 2a that comprises the packaging body 2 consists of a material that can seal the swallowing aid substance 1, and for example contains the polyethylene. With reference to FIG. 3 and FIG. 4, the packaging body 2 is arranged so as to overlap one side and other side by bending a film 2a, and contains the first seal S1 where overlapped film 2a was heat sealed. The swallowing aid substance 1 is constructed to enable the flow from the inside of the packaging body 2 by destroying the first seal S1, to the inside of the divided bag 4 and external to the packaging body 2. With reference to FIG. 1 and FIG. 3, preferably the packaging body 2 further includes the second seal S2 that is set in the opposite side to the direction where the swallowing aid substance 1 is provided with respect to the first seal S1, and has higher seal strength than the first seal S1. The size of the second seal S2, extending along the longitudinal direction of the first seal S1, is smaller than the size of the first seal S1. The seal strength of the first seal S1 is, for example, about ≧50 gf/15 mm and ≦300 gf/15 mm, preferably about ≧100 gf/15 mm and ≦200 gf/15 mm. The seal strength of the second seal S2 is, for example, about ≧500 gf/15 mm, preferably about ≧600 gf/15 mm. The seal strength can be measured by the method described in JIS Z 0238.

Preferably, the second seal S2, is set so as to separate the flow when the swallowing aid substance 1 flows from the inside of the packaging body 2, to the inside of the divided bag 4 and external to the packaging body 2. Preferably, the second seal S2 is constructed so that the swallowing aid substance 1 can be smashed when the external pressure is applied to swallowing aid substance 1. When multiple second seals S2 are set, then the space x of the adjoining second seal S2 is, for example, about ≧5 mm and ≦15 mm, preferably about ≧7 mm and ≦13 mm. As shown in the working example described later, if the concerned space x is ≧7 mm, then the load required to destroy the first seal S1 can be greatly reduced. If the concerned space x is ≦13 mm, then the jelly with the size that can be easily administered to the person can be formed. The distance y between the first seal S1 along the perpendicular direction to the direction where the first seal S1 is extended and the second seal S2 is, for example, about 3 mm, preferably ≧3 mm. As shown in FIG. 2, the packaging body 2 has the third seal S3 at one side edge and the other side edge along the direction where the first seal S1 is extended. The seal strength of the third seal S3 is higher than seal strength of the first seal S1, and is the same level as the seal strength of the second seal S2. In other words, the packaging body 2 seals the swallowing aid substance 1 by the first seal S1 and the third seal S3. The packaging body 2 may also seal the swallowing aid substance 1 by sealing the entire circumference with the first seal S1.

For example, the drug 3 is a solid medicine like tablet and capsule, and is disposed inside the divided bag 4 and external to the packaging body 2. For example, the drug 3 is used for diagnoses, treatment or prevention of an epidemic, and is prescribed at the pharmacy, based on the prescription of a doctor or a dentist. For example, the drug 3 may also be a non-prescription drug etc., excluding the ethical drug. For example, the drug 3 may also be supplements such as vitamins.

The divided bag 4, for example, consists of general medicine wrapping paper such as glassine paper or cellophane paper, and each of the packaging body 2 sealed with the swallowing aid substance 1 and the drug 3 are accommodated in the inside and sealed. In other words, packaging body 2 sealed with the swallowing aid substance 1 and the drug 3 are sealed by the divided bag 4. The sealing of the packaging body 2 and drug 3 by the divided bag 4 means, the state where the packaging body 2 and drug 3 are sealed by the divided bag 4 itself, and not the state where the packaging body 2 and drug 3 are sealed by using materials other than the divided bag 4. The divided bag 4 has an approximately rectangular outer shape in planar view (View when the divided packet 10 is kept in a horizontal plane and seen from the perpendicular direction). In the planar view, the packaging body 2 and drug 3 may be sealed by the divided bag 4, by forming the seal along the entire outer circumference of divided bag 4. It is not necessary to completely make an airtight seal of the divided bag 4, but may be sealed to the extent that the deterioration of the drug 3 can be substantially controlled, by exposing the drug 3 to the external air of divided bag 4. The water absorbability of the above-mentioned medicine wrapping paper may be higher than film 2a that comprises the packaging body 2, because it is used to accommodate the packaging body 2 and drug 3, and does not seal the liquid.

With reference to FIG. 3 and FIG. 4, the divided bag 4 contains the first medicine wrapping paper 4a, second medicine wrapping paper 4b, fourth seal S4, and fifth seal S5. One edge of the first medicine wrapping paper 4a is heat sealed with one edge of the second medicine wrapping paper 4b by the fourth seal S4, and the other edge of the first medicine wrapping paper 4a is heat sealed with other edge of the second medicine wrapping paper 4b by the fifth seal S5. As a result, a space enclosed by the first medicine wrapping paper 4a, second medicine wrapping paper 4b, fourth seal S4, and fifth seal S5 is formed, and each of packaging body 2 sealed with the swallowing aid substance 1 and the drug 3 are accommodated in the concerned space and sealed. Each of the fourth seal S4 and fifth seal S5 has higher seal strength than the first seal S1. The seal strength of each of the fourth seal S4 and fifth seal S5 is, for example, about ≧400 gf/15 mm, and preferably about ≧500 gf/15 mm. The fifth seal S5 as described later is a seal, formed by closing the opening formed in the divided bag 4 by heat sealing.

The portion-to-be-unsealed 5 is a portion where the divided bag 4 will be cut when unsealing the divided bag 4. The portion-to-be-unsealed 5, for example, is the print portion printed with the ink on the outer surface (The surface on the opposite side of the direction where the packaging body 2 and drug 3 are provided) of the first medicine wrapping paper 4a of the divided bag 4. The portion-to-be-unsealed 5, for example, may be at the notch (cut) provided in the first medicine wrapping paper 4a or second medicine wrapping paper 4b. For example, the notch is I type or V type. Preferably, the extending direction of the portion-to-be-unsealed 5 is the direction where both the longitudinal direction and transverse direction of the divided bag 4 intersect. Preferably, the size of portion-to-be-unsealed 5 is smaller than the size in the transverse direction of the divided bag 4 in planar view. The portion-to-be-unsealed 5, for example, may be minute perforated holes made in the first medicine wrapping paper 4a or the second medicine wrapping paper 4b with a sewing-machine needle. Preferably, in the planar view, the portion-to-be-unsealed 5 is set at the direction opposite to the first seal S1 with respect to the swallowing aid substance 1.

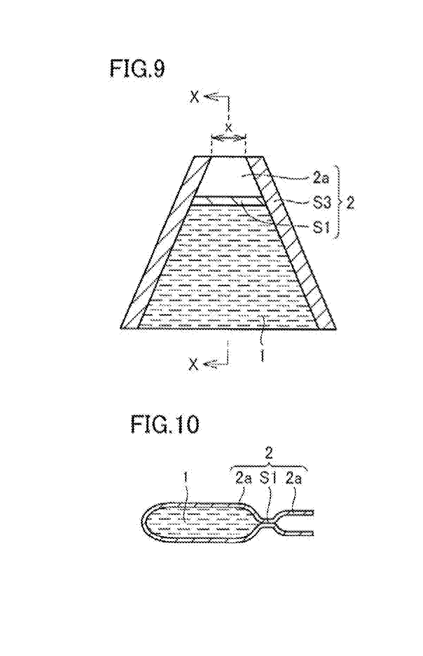

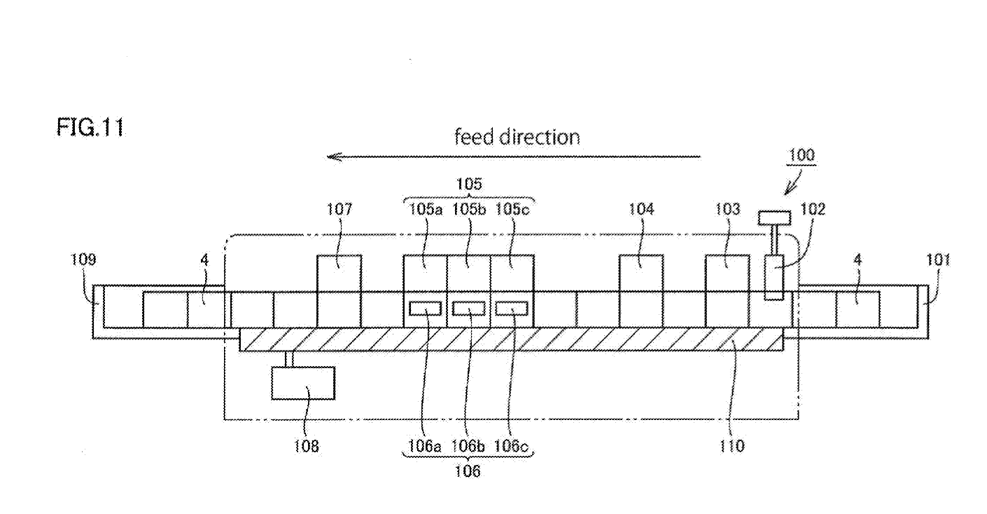

With reference to FIG. 9 and FIG. 10, the packaging body 2 may have an approximately trapezoidal shape in planar view. The packaging body 2 may not have the second seal S2 provided in the opposite side to the side where swallowing aid substance 1 is provided with respect to the first seal S1. The third seals S3 are provided one each at the edge in the direction where the first seal S1 is extended and the other at the opposite edge. The third seal S3 has higher seal strength than the first seal S1. The space x of the third seal S3 along the direction where the first seal S1 is extended is, for example, about ≧5 mm and ≦15 mm, preferably ≧7 mm and ≦13 mm. The swallowing aid substance 1 is constructed to enable the flow from the inside of the packaging body 2 by destroying the first seal S1, to the inside of the divided bag 4 and external to the packaging body 2. As shown in the FIG. 10, the first seal S1 may be formed, by bending and overlapping a film 2a so that one edge and the other edge face each other, and by heat sealing the overlapped film 2a. In the planar view, the outer circumference of the packaging body 2 may be sealed only by the first seal S1.

Each of the film 2a that comprises the packaging body 2 and the medicine wrapping paper that comprises the divided bag 4, contains the sealant layer that can be heat sealed. In other words, each of the film 2a, that comprises the packaging body 2 and the medicine wrapping paper that comprises the divided bag 4, contains the sealant layer and another layer with high melting point than the sealant layer. Preferably, the film 2a that comprises packaging body 2 contains a material that can fluid-tightly seal the swallowing aid substance 1. The film 2a that comprises the packaging body 2 may include, for example, the plastic laminated multilayer film like the Polyethylene terephthalate, Polybutylene terephthalate, Nylon, Polypropylene or Polyethylene etc.

Next, the use method of the divided packet 10 related to embodiment 1 of this invention is explained.

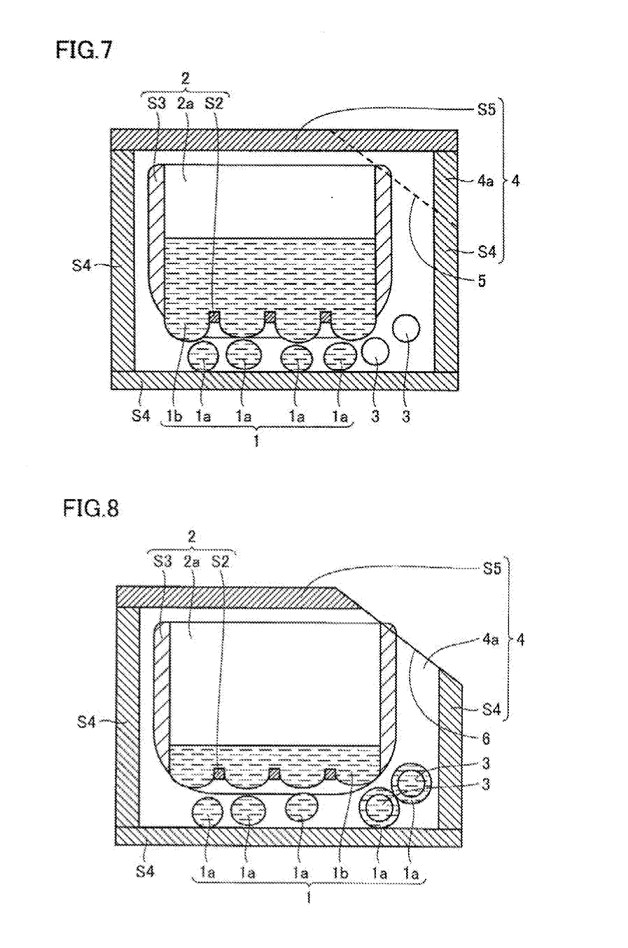

First, as shown in FIG. 1, the divided packet 10 sealed with the packaging body 2 sealed with the swallowing aid substance 1 and the drug 3 disposed on the exterior of packaging body 2 by the divided bag 4 are prepared. Next, with reference to FIG. 5, the swallowing aid substance 1 accommodated inside the packaging body 2 is pressed towards the first seal S1 though the packaging body 2, by applying the load F, for example, with the finger from the exterior of the divided bag 4. When the force applied to the first seal S1 exceeds the seal strength of the first seal S1, the first seal S1 is destroyed, and the packaging body 2 is unsealed. With reference to FIG. 6 and FIG. 7, by continuously applying the load F to the swallowing aid substance 1 through the film 2a from the exterior, the swallowing aid substance 1 flows to the inside of the divided bag 4, by squeezing from the space between the two adjoining second seals S2, and from the space between the third seal S3 and the second seal S2. The swallowing aid substance 1 is smashed by passing between the two adjoined second seals S2 or between the third seal S3 and the second seal S2, and becomes granular. In other words, multiple formations of the granular swallowing aid substance 1a are formed inside the divided bag 4 and external to the packaging body 2. The swallowing aid substance 1b remaining inside the packaging body 2, is squeezed inside the divided bag 4 and external to the packaging body 2, by applying the load F to the swallowing aid substance 1 through packaging body 2 from the exterior.

Next, with reference to FIG. 8, the swallowing aid substance 1 is mixed together with the drug 3 so that granular swallowing aid substance 1 may wrap the drug 3 by using the finger from the exterior of the divided bag 4. When the swallowing aid substance 1 sufficiently wraps around the drug 3, the divided bag 4 is unsealed by cutting the divided bag 4 along the portion-to-be-unsealed 5. The drug 3 attached to the swallowing aid substance 1 is taken out from the divided bag 4 through the opening 6 of divided bag 4, and administered. The swallowing aid substance 1 enters the oral cavity, by attaching with the drug 3 so as to wrap the drug 3, and is carried to the stomach by passing the throat and esophagus. The drug 3 can pass the inner wall of the throat and esophagus smoothly, because the swallowing aid substance 1 is attached so as to wrap the drug 3. Hence, the drug 3 can be administered without any difficulty, even to persons with swallowing disorder. When the drug 3 is administered, it can be administered without the sensation of medicine specific bitterness, because the swallowing aid substance 1 is adhered with the drug 3 so as to wrap the drug 3.

Next, the manufacturing device 100 of the divided packet 10 related to embodiment 1 of this invention is explained.

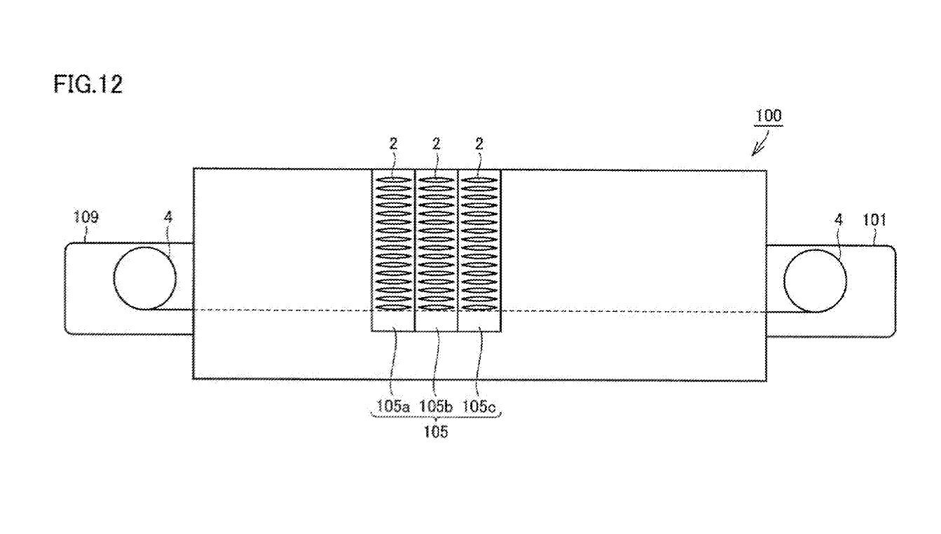

With reference to FIG. 11 and FIG. 12, the manufacturing device 100 of the divided packet 10 related to this invention mainly consists of the divided bag inserter 101, height adjuster 102, cut-off line printer 103, divided bag unsealer 104, packaging body inserter 105, adsorption pad 106, divided bag sealer 107, motor 108, divided bag collector 109 and feed belt 110.

The divided bag inserter 101 is constructed to enable the insertion of a medicine wrapping paper which has multiply-connected divided bag 4 sealed with the drug 3 in the inside. The divided bag collector 109 is constructed to enable the collection of a medicine wrapping paper which has multiply-connected divided bag 4 sealed with drug 3 and the packaging body 2 sealed with the swallowing aid substance 1. As shown in FIG. 12, the medicine wrapping paper with the divided bag 4 multiply-connected is wrapped in a roll shape and provided in the divided bag inserter 101. The medicine wrapping paper with the multiply-connected divided bag 4 is collected in the divided bag collector 109 by wrapping in a roll shape. As shown in FIG. 11, the divided bag inserter 101 and divided bag collector 109 are provided on one side and other side of the manufacturing device 100 of divided packet 10 respectively.

The feed belt 110 is constructed to enable the movement of the multiply-connected divided bag 4 from the divided bag inserter 101 to the divided bag collector 109. Feed belt 110 has a ring shape, and is constructed to enable the rotation along the circular shape by motor 108. The feed belt 110 is fixed so that it can be extended from the location where the height adjuster 102 is provided to the location where the divided bag sealer 107 is provided. The feed belt 110 is provided so as to the partly touch the outer surface of the divided bag 4, and move the divided bag 4 along the rotation of the feed belt 110.

The height adjuster 102 is constructed to enable the height adjustment of the divided bag 4 along the vertical direction towards each of the connecting direction of the multiply-connected divided bag 4 and along the normal direction of the outer surface of the divided bag 4. The cut-off line printer 103, is fixed at the side of divided bag collector 109 from the height adjuster 102, and is constructed to enable printing of cutoff line that becomes the portion-to-be-unsealed 5 on the outer surface of the divided bag 4. The cut-off line printer 103 may either be constructed to enable the formation of the cut (Notch) that becomes the portion-to-be-unsealed 5 in the divided bag 4, or constructed to enable the formation of each of the cut-off line and cut-in portion. The divided bag unsealer 104, is fixed at the side of divided bag collector 109 from the cut-off line printer 103, and is constructed to enable the unsealing of the divided bag 4 which seals in the drug 3. In particular, the cutter is constructed so as to touch near the top of the outer surface of the divided bag 4, and to enable the formation of an opening on top of the outer surface of the divided bag 4, by moving the divided bag 4 from the divided bag inserter 101 towards the divided bag collector 109, and by cutting near the top of the outer surface of the divided bag 4.

The packaging body inserter 105, is set on the side closer to the divided bag collector 109 than the divided bag unsealer 104, and is constructed to enable the provision of the packaging body 2 sealed with the swallowing aid substance 1, inside the divided bag 4 that has the opening formed by the divided bag unsealer 104. The packaging body inserter 105 has a cassette that can accommodate the packaging body 2 sealed with the multiple swallowing aid substances 1. The packaging body inserter 105, is provided on the upper side of the divided bag 4 (On the opposite side to the side where the feed belt 110 is provided with respect to the divided bag 4), and is constructed to enable the provision of the packaging body 2 inside the divided bag 4 by dropping the packaging body 2 inside the divided bag 4 using gravity. The position detection sensor (Not shown in figure) to detect the position of divided bag 4, is set at the position opposite to the outer surface of the divided bag 4, and the packaging body inserter 105 may be constructed so that the packaging body 2 is inserted from the packaging body inserter 105 to the inside of the divided bag 4, when the divided bag 4 that has the opening is placed directly below the packaging body inserter 105. As shown in FIG. 12, the multiple packaging bodies 2 are accommodated in the cassette of the packaging body inserter 105 along the vertical direction to each of the traveling direction of the divided bag 4 and the height direction of the divided bag 4.

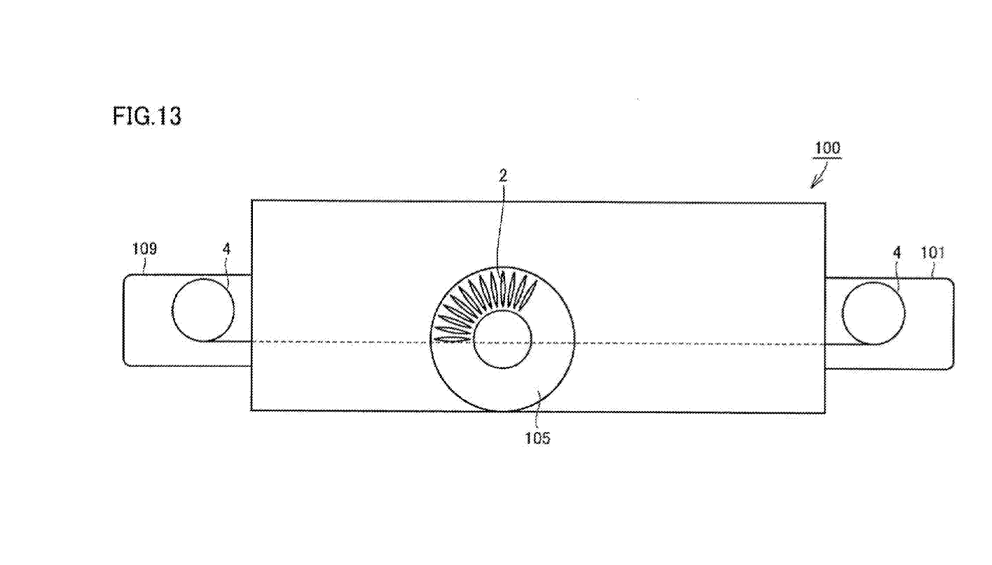

The packaging body inserter 105, may have multiple packaging body inserters, provided along the traveling direction of the divided bag 4. The packaging body inserter 105, for example, may have the first packaging body inserter 105a, the second packaging body inserter 105b, and the third packaging body inserter 105c. The packaging body 2 for morning may be provided in the first packaging body inserter 105a, the packaging body 2 for noon may be provided in the second packaging body inserter 105b, and the packaging body 2 for night may be provided in the third packaging body inserter 105c. For example, forgetting to administer the drug 3 can be prevented by making different colors of the packaging body 2 for morning, noon and night time. As shown in FIG. 13, the packaging body inserter 105, is formed like a ring shape, and may accommodate multiple packaging bodies 2 in the ring shape. The manufacturing device 100 of divided packet 10 can be made compact by forming the packaging body inserter 105 in ring shape, instead of forming the packaging body inserter 105 in linear shape.

The adsorption pad 106 is provided so that it faces the outer surface of the divided packet 4, and is constructed to enable the adsorption on the outer surface of the divided packet 4. While the adsorption pad 106 is in adsorbed state on the outer surface of the divided packet 4, the opening formed by the divided bag unsealer 104 can be widened by moving along the direction of normal line of the outer surface. As a result, the packaging body 2 can be inserted inside the divided bag 4 with good accuracy. It is desirable that the packaging body inserter 105 is constructed so that the packaging body 2 is inserted in the divided bag 4, while the adsorption pad 106 widens the opening of the divided bag 4.

The divided bag sealer 107, is set on the side closer to the divided bag collector 109 than the packaging body inserter 105 and adsorption pad 106, and is constructed to enable sealing of the divided bag 4 by closing the opening of the divided bag 4 disposed with the drug 3 and packaging body 2 sealed with the swallowing aid substance 1. The divided bag sealer 107, for example, is a heater for heat sealing, provided so that it faces the top of the outer surface of the divided bag 4, and constructed to enable the sealing by heat sealing the opening of the divided bag 4. The divided bag 4 that is sealed by heat sealing is sent to the divided bag collector 109 and collected.

In manufacturing device 100 of the divided packet 10 related to the above-mentioned embodiment 1, it was explained that the cut-off line printer 103 was provided between the divided bag inserter 101 and the divided bag unsealer 104, but the cut-off line printer 103 may also be provided between the divided bag sealer 107 and the divided bag collector 109.

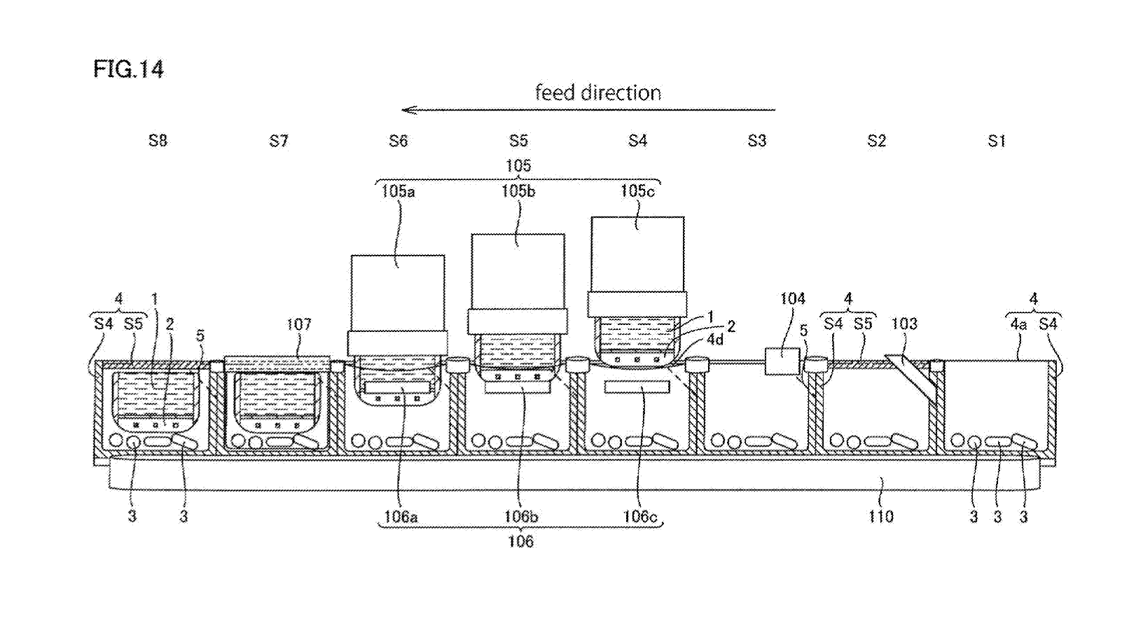

Next, the method of manufacturing the divided packet 10 related to embodiment 1 of this invention is explained. The divided bag preparation process (S1: FIG. 14) is performed by referring to FIG. 14. In the divided bag preparation process (S1: FIG. 14), the divided bag 4 sealed with the drug 3 in the inside is prepared. For example, the drug 3 prepared by the pharmacist based on Doctor's prescription is disposed in the divided bag 4, and the concerned divided bag 4 is sealed. The divided bag 4 sealed with the drug 3 is provided inside the divided bag inserter 101.

Next, the portion-to-be-unsealed formation process (S2: FIG. 14) is performed. In the portion-to-be-unsealed formation process (S2: FIG. 14), the cut-in line is printed as the portion-to-be-unsealed 5 on the outer surface of the divided bag 4 disposed with the drug 3. In particular, the divided bag 4 is moved facing along the direction (feed direction) from the divided bag inserter 101 to the divided bag collector 109 by the feed belt 110, and sent to cut-off line printer 103. In the cut-off line printer 103, cut-in line is printed on the outer surface of the divided bag 4. The cut (Notch) may be formed as the portion-to-be-unsealed 5 in the divided bag 4, along with the printing of the cut-in line as well.

Next, the opening formation process (S3: FIG. 14) is performed. In the opening formation process (S3: FIG. 14), the opening 4d is formed in the divided bag 4 disposed with the drug 3. In particular, the divided bag 4 is sent from the cut-off line printer 103 to the divided bag unsealer 104 by the feed belt 110. In the divided bag unsealer 104, the top of the outer surface of the divided bag 4 is cut and opening 4d is formed, by moving the divided bag 4 along the moving direction of the divided bag 4, with the cutter pushing against the top of the outer surface of the divided bag 4 disposed with the drug 3.

Next, the packaging body insertion process (S4˜6: FIG. 14) is performed. In the packaging body insertion process (S4˜6: FIG. 14), the packaging body 2 sealed with the swallowing aid substance 1 is provided inside the unsealed divided bag 4, through the opening 4d of the divided bag 4. In particular, the divided bag 4 is sent from the divided bag unsealer 104 to the packaging body inserter 105 by the feed belt 110. The packaging body 2 accommodated in the cassette of packaging body inserter 105 is inserted from the upper side of the divided bag 4 to the inside of divided bag 4 through the opening 4d. It is desirable to widen the opening 4d of the divided bag 4 by the adsorption pad 106, when the packaging body 2 is inserted inside the divided bag 4. For example, the opening 4d of the divided bag 4 is widened by the adsorption pad 106 by moving in the normal direction of the outer surface of the divided bag 4 in the adsorbed state on the outer surface of the divided bag 4. Preferably, the packaging body 2 sealed with the swallowing aid substance 1 is inserted from different packaging body inserters 105 at the same time, to each of the three connected divided bags 4. As stated above, the divided bag 4 that has the opening 4d and provided with the packaging body 2 sealed with the swallowing aid substance 1 in the inside and drug 3 is prepared.

Next, the divided bag sealing process (S7: FIG. 14) is performed. In the divided bag sealing process (S7: FIG. 14), the packaging body 2 sealed with the swallowing aid substance 1 and the drug 3 is sealed by the divided bag 4. In particular, the divided bag 4 is sent from packaging body inserter 105 to the divided bag sealer 107 by the feed belt 110. In the divided bag sealer 107, the opening 4d of the divided bag 4 is heated by the heater, and the opening 4d of the divided bag 4 is closed by heat sealing. As a result, the packaging body 2 sealed with the swallowing aid substance 1 and the drug 3 is sealed by the divided bag 4. When the packaging body 2 and the drug 3 are sealed by the divided bag 4, the opening 4d may be closed by heat sealing by pushing the roller against the outer surface of the divided bag 4, so as to push the air inside the divided bag 4 to the exterior. The fifth seal S5 is formed by closing the opening 4d of the divided bag 4 by heat sealing.

Next, the divided bag collection process (S8: FIG. 14) is performed. In the divided bag collection process (S8: FIG. 14), the divided bag 4 is sent from the divided bag sealer 107 to the divided bag collector 109 by the feed belt 110. In the divided bag collector 109, the divided packet 10 in which the drug 3 and the packaging body 2 sealed with the swallowing aid substance 1 sealed by the divided bag 4 are collected.

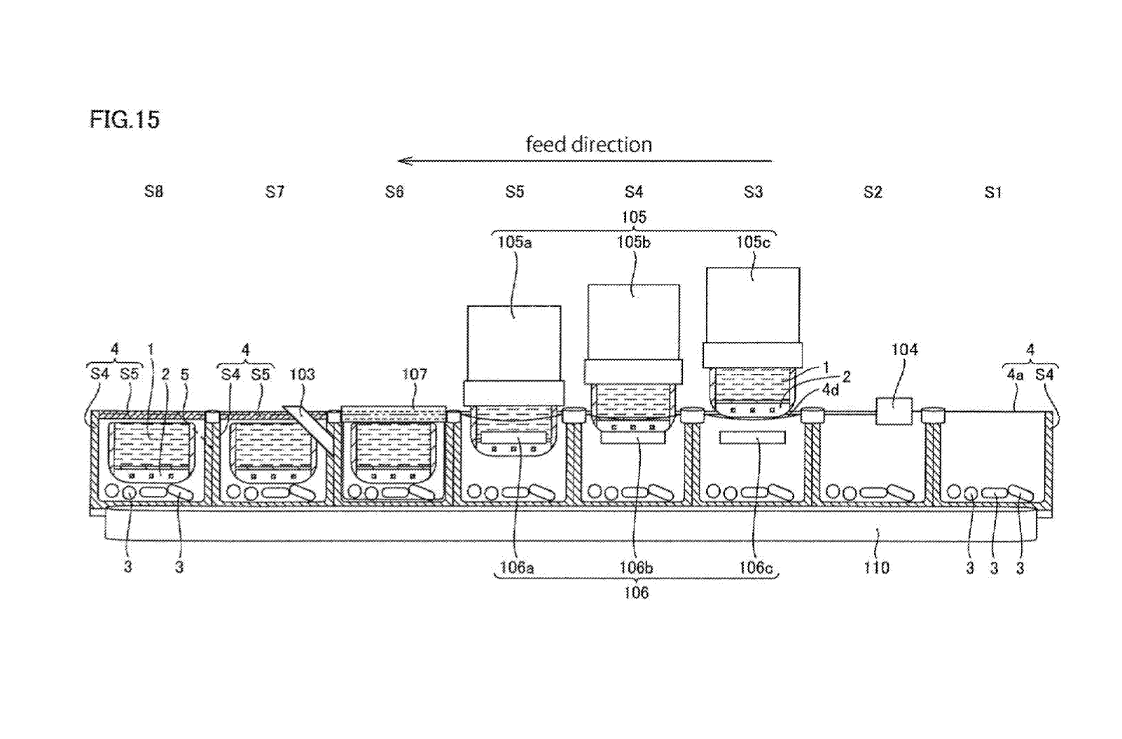

In the method of manufacturing the divided packet 10 related to the above-mentioned embodiment 1, the case when the portion-to-be-unsealed formation process (S2: FIG. 14) is performed before the opening formation process (S3: FIG. 14) was explained, but the portion-to-be-unsealed formation process (S2: FIG. 14) may also be performed after the opening formation process (S3: FIG. 14). In particular, as shown in FIG. 15, the packaging body insertion process (S3-5: FIG. 15) and the divided bag sealing process (S6: FIG. 15) are sequentially performed after the opening formation process (S2: FIG. 15). The portion-to-be-unsealed formation process (S7: FIG. 15) may also be performed after the divided bag sealing up process (S6: FIG. 15). The portion-to-be-unsealed 5 can be formed in the fifth seal S5 of divided bag 4, by performing the portion-to-be-unsealed formation process (S7: FIG. 15) after the divided bag sealing process (S6: FIG. 15).

In the method of manufacturing the divided packet 10, the opening formation process (S3: FIG. 14) may be omitted. For example, the divided bag 4 that has the opening is prepared by heat sealing a portion of the medicine wrapping paper that does not accommodate both the drug 3 and the packaging body 2. Next, the drug 3 and the packaging body 2 sealed with the swallowing aid substance 1 are inserted, inside the divided bag 4 that has the opening. Next, the opening of divided bag 4 is closed by heat sealing, so as to seal the drug 3 and the packaging body 2 sealed with the swallowing aid substance 1. As stated above, the divided packet 10 having the packaging body 2 sealed with the swallowing aid substance 1, the drug 3 disposed in the exterior of packaging body 2, the divided bag 4 which seals the drug 3 and the packaging body 2 sealed with the swallowing aid substance 1, and with the packaging body 2 and the drug 3 sealed by the divided bag 4, can be manufactured.

### Embodiment 2

Next, the composition of the divided packet 10 related to embodiment 2 of this invention is explained.

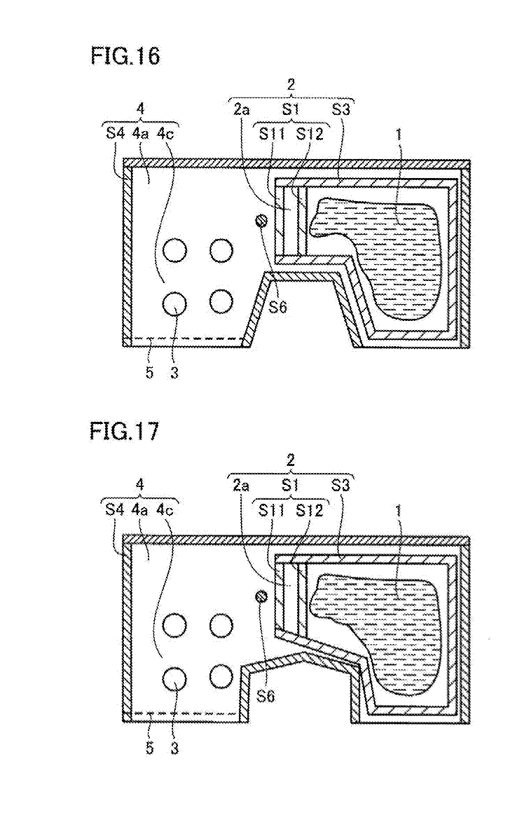

With reference to FIG. 16 and FIG. 17, the divided packet 10 related to embodiment 2 mainly has the packaging body 2 sealed with the swallowing aid substance 1, the drug 3, and the divided bag 4. The material of swallowing aid substance 1 and packaging body 2, and the material of drug 3 and divided bag 4 related to embodiment 2 is same as the material of swallowing aid substance 1 and packaging body 2, and the material of drug 3 and divided bag 4 explained in embodiment 1.

The divided bag 4 internally accommodates and seals each of the packaging body 2 sealed with the swallowing aid substance 1 and the drug 3. In other words, the packaging body 2 sealed with the swallowing aid substance 1 and the drug 3 is sealed by the divided bag 4. In the planar view, the divided bag 4 has a polygonal outer shape. As shown in FIG. 16, the divided bag 4 may also have an octagonal outer shape, and as shown in FIG. 17, the divided bag 4 may also have a nonagonal outer shape. The size of the transverse direction of the divided bag 4 near the center of the longitudinal direction of the divided bag 4 is smaller than the size of the transverse direction of the divided bag 4 near the edge of the longitudinal direction of the divided bag 4. The divided bag 4 may also be formed by folding one medicine wrapping paper 4a so that one side edge and other side edge of the medicine wrapping paper 4a face each other. The circumference other than the portion folded by the medicine wrapping paper 4a is heat sealed by the fourth seal S4. In the planar view, the entire circumference of the divided bag 4 may also be heat sealed by the fourth seal S4. The sixth seal S6 is formed so as to heat seal the medicine wrapping paper 4a overlapped near the center of divided bag 4. The sixth seal S6 is the seal with approximate circular shape in planar view. The seal strength of each of the fourth seal S4 and sixth seal S6 is, for example, about ≧400 gf/15 mm, and preferably about ≧500 gf/15 mm. The mixing room 4c is formed inside the divided bag 4 on the side opposite to the side where packaging body 2 is provided with respect to the sixth seal S6. The drug 3 is disposed in the mixture room 4c. The mixture room 4c has a space wide enough so that the swallowing aid substance 1 and the drug 3 can be thoroughly mixed.

With reference to FIG. 16, the packaging body 2 has a hexagonal shape in planar view, and has the first seal S1 and the third seal S3 that has higher seal strength than the first seal S1. The swallowing aid substance 1 is accommodated inside the packaging body 2. The packaging body 2 is sealed with the swallowing aid substance 1. The swallowing aid substance 1 is constructed to enable the flow from the inside of packaging body 2 by destroying the first seal S1, to the inside of the divided bag 4 and external to the packaging body 2. The first seal S1 may have the first weak seal S11 and second weak seal S12. The first weak seal S11 separates the space with the second weak seal S12, and is provided in parallel. The elongation direction of each of the first weak seal S11 and second weak seal S12 is the direction that intersects the flow direction of the swallowing aid substance 1. The sixth seal S6 is provided on the side opposite to the side where the swallowing aid substance 1 is provided with respect to the first seal S1. The size of the sixth seal S6 along the direction in which the first seal S1 is extended, is smaller than the size of the first seal S1. The seal strength of each of the first weak seal S11 and second weak seal S12 is, for example, about ≧50 gf/15 mm and ≦300 gf/15 mm, preferably about ≧100 gf/15 mm and ≦200 gf/15 mm. The seal strength of second seal S2 is, for example, about ≧500 gf/15 mm, preferably about ≧600 gf/15 mm.

The cut-off portion is printed as the portion-to-be-unsealed 5 on the outer surface of the medicine wrapping paper 4a of divided bag 4. The portion-to-be-unsealed 5 is the position in which divided bag 4 is cut when unsealing the divided bag 4. In the mixture room 4c of divided bag 4, the portion-to-be-unsealed 5 is formed so that the drug 3 can be taken out to the exterior of divided bag 4 along the transverse direction of divided bag 4. The portion-to-be-unsealed 5, for example, may also be the notch (cut) provided in the medicine wrapping paper 4a. The portion-to-be-unsealed 5, for example, may also be minute perforated holes made in the first medicine wrapping paper 4a with a sewing-machine needle. In the mixture room 4c, the portion-to-be-unsealed 5 is cut after mixing the swallowing aid substance 1 with the drug 3, and the opening is formed in the divided bag 4. The size in the opening is smaller than the size of transverse direction of the divided bag 4. The drug 3 mixed with swallowing aid substance 1 is taken from the divided bag 4 through the opening and administered.

### Embodiment 3

Next, the construction of the divided packet 10 related to embodiment 3 of this invention is explained. The construction of the divided packet 10 related to embodiment 3, is different from the construction of the divided packet 10 related to embodiment 2 in the position of the portion-to-be-unsealed 5 and the outer shape of the divided bag 4 in the planar view, and is almost the same as the construction of the divided packet 10 related to embodiment 2 for other constructions. Hereafter, the points that are different from the construction of embodiment 2 are explained.

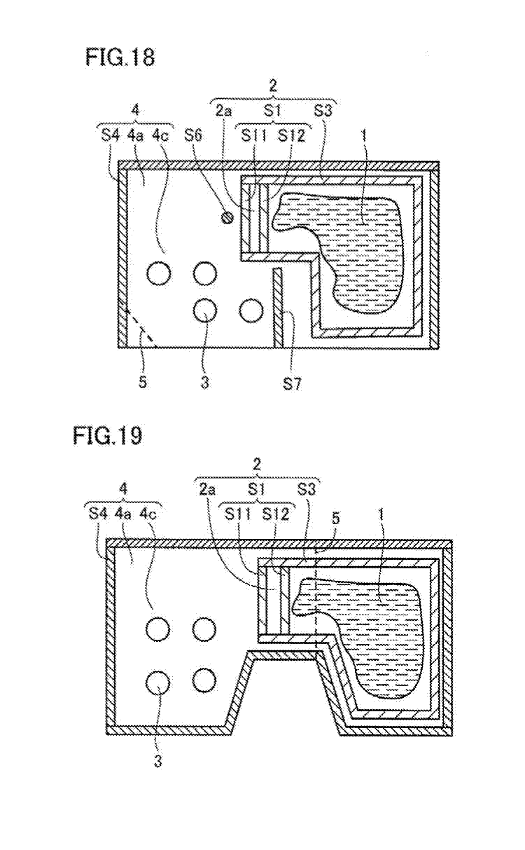

With reference to FIG. 18, the divided bag 4 of divided packet 10 related to embodiment 3 has a rectangular outer shape in planar view. The seventh seal S7 extending along the transverse direction is fixed near the center of the longitudinal direction of divided bag 4. The seventh seal S7 and the sixth seal S6 function as a stopper so that packaging body 2 does not move to the mixture room 4c of the divided bag 4.

The portion-to-be-unsealed 5 is formed on the outer surface of the mixing chamber of the divided bag 4, so that it extends towards the intersecting directions of both the longitudinal direction and transverse direction of the divided bag 4. When the portion-to-be-unsealed 5 is cut, the opening that can take out the drug 3 from the intersecting directions of both the longitudinal direction and transverse direction of the divided bag 4 can be formed.

### Embodiment 4

Next, the construction of the divided packet 10 related to embodiment 4 of this invention is explained. The construction of the divided packet 10 related to embodiment 4, is different from the construction of the divided packet 10 related to embodiment 2 in the position of the portion-to-be-unsealed 5, and is almost the same as the construction of the divided packet 10 related to embodiment 2 for other constructions. Hereafter, the points that are different from the construction of embodiment 2 are explained.

With reference to FIG. 19, the portion-to-be-unsealed 5 of divided packet 10 related to embodiment 4, is formed so as to extend along the transverse direction of divided bag 4, near the center in the longitudinal direction of divided bag 4. The sixth seal S6 is not formed in the divided bag 4.

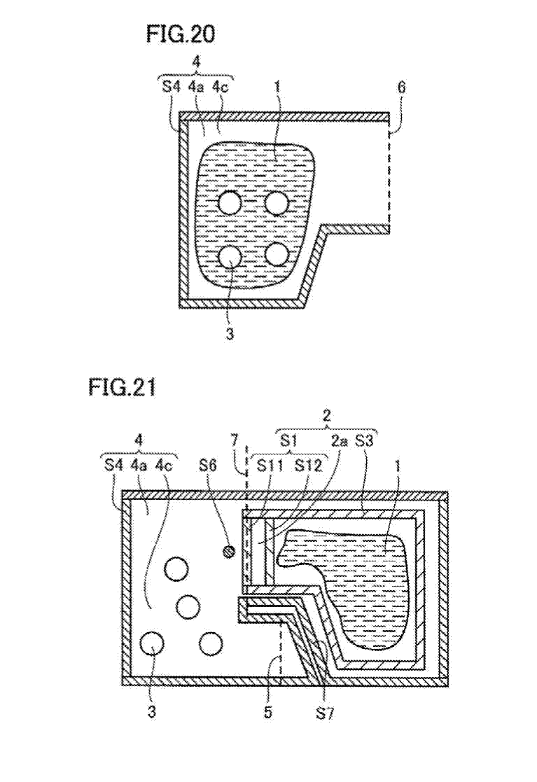

The swallowing aid substance 1 is introduced from the inside of packaging body 2 to the mixture room 4c of divided bag 4, by destroying the first seal S1. After mixing the swallowing aid substance 1 with the drug 3 in mixture room 4c, the divided bag 4 is cut in the portion-to-be-unsealed 5. As shown in FIG. 20, the opening 6 is formed near the center of the longitudinal direction of the divided bag 4, by removing the portion on side opposite to the mixture room 4c of the divided bag 4 and the packaging body 2 from which the swallowing aid substance 1 is discharged. The opening 6 is formed so as to take out the drug 3 along the longitudinal direction of the divided bag 4.

### Embodiment 5

Next, the construction of the divided packet 10 related to embodiment 5 of this invention is explained. The construction of the divided packet 10 related to embodiment 5, is different from the construction of the divided packet 10 related to embodiment 2 in the position of the portion-to-be-unsealed 5 and the outer shape of the divided bag 4, and is almost the same as the construction of the divided packet 10 related to embodiment 2 for other constructions. Hereafter, the points that are different from the construction of embodiment 2 are explained.

With reference to FIG. 21, the divided bag 4 of divided packet 10 related to embodiment 5 has a decagonal shape, and after forming the cut in the slanting direction towards both the long boundary and short boundary from the long boundary of the divided bag 4, the cut is formed continuously along the longitudinal direction. The fold position 7 that can fold-back the divided bag 4 in the longitudinal direction is formed near the center position along the longitudinal direction of divided bag 4, and the portion-to-be-unsealed 5 is formed on the side opposite to the side where the sixth seal S6 is formed with respect to the fold position 7.

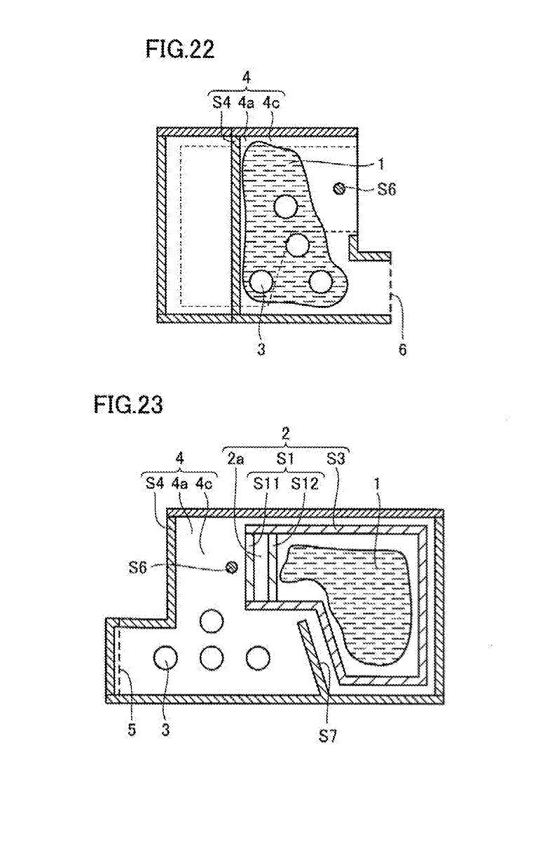

With reference to FIG. 22, the divided bag 4 can be bent at the fold position 7, after the swallowing aid substance 1 is mixed with the drug 3 in mixture room 4c. The divided bag 4 is cut in the portion-to-be-unsealed 5. The opening 6 is formed near the center of the longitudinal direction of the divided bag 4. The opening 6 is formed so as to take out the drug 3 along the longitudinal direction of the divided bag 4.

### Embodiment 6

Next, the construction of the divided packet 10 related to embodiment 6 of this invention is explained. The construction of the divided packet 10 related to embodiment 6, is different from the construction of the divided packet 10 related to embodiment 2 in the position of the portion-to-be-unsealed 5 and the outer shape of the divided bag 4, and is almost the same as the construction of the divided packet 10 related to embodiment 2 for other constructions. Hereafter, the points that are different from the construction of embodiment 2 are explained.

With reference to FIG. 23, a portion in the short side of the rectangle in the divided bag 4 of divided packet 10 related to this embodiment 6, has a projection that protrudes along the longitudinal direction and has a hexagonal outer shape. The portion-to-be-unsealed 5 is formed at the edge of the concerned projection. In the center of longitudinal direction of the divided bag 4, the seventh seal S7 is formed so as to extend in the slanting direction towards each of the long boundary and short boundary from the long boundary of the divided bag 4.

### Embodiment 7

Next, the construction of the divided packet 10 related to embodiment 7 of this invention is explained. The construction of the divided packet 10 related to embodiment 7, is different from the construction of the divided packet 10 related to embodiment 2 in the outer shape of the divided bag 4 and the position of the portion-to-be-unsealed 5, and is almost the same as the construction of the divided packet 10 related to embodiment 2 related to other constructions. Hereafter, the points that are different from the construction of embodiment 2 are explained.

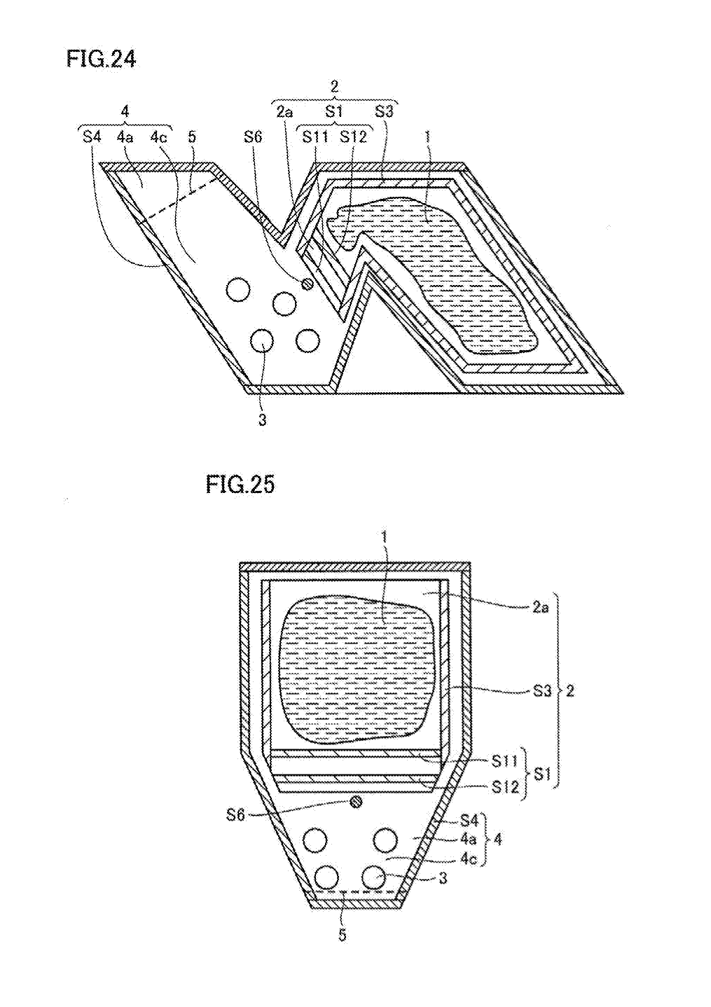

With reference to FIG. 24, the short boundary of the divided bag 4 of divided packet 10 related to embodiment 7, is formed so as to incline towards the long boundary. The cut is formed in the center portion of the longitudinal direction of divided bag 4. The seventh seal S7 is formed so as to extend in the slanting direction towards each of the long boundary and short boundary from the long boundary of the divided bag 4, near the center of longitudinal direction of the divided bag 4. The packaging body 2 has a heptagonal outer shape in planar view. The portion where the first seal S1 of packaging body 2 is formed is bent at the central portion of the longitudinal direction of divided bag 4. The portion-to-be-unsealed 5 is formed by extending along the vertical direction towards the short boundary of the divided bag 4.

### Embodiment 8

Next, the construction of the divided packet 10 related to embodiment 8 of this invention is explained. The construction of the divided packet 10 related to embodiment 8, is different from the construction of the divided packet 10 related to embodiment 2 in the outer shape of the divided bag 4 and the position of the portion-to-be-unsealed 5, and is almost the same as the construction of the divided packet 10 related to embodiment 2 related to other constructions. Hereafter, the points that are different from the construction of embodiment 2 are explained.

With reference to FIG. 25, the divided bag 4 of the divided packet 10 related to embodiment 8, has hexagonal outer shape formed so that one side of the trapezoidal part touches one side of the square part, in planar view. The packaging body 2 has a hexagonal outer shape in the planar view, and is provided in the square portion of divided bag 4. The drug 3 is provided in the trapezoid portion of divided bag 4. The portion-to-be-unsealed 5 is formed on the outer surface of the divided bag 4 on the side opposite to the side where packaging body 2 is provided for the sixth seal S6.

Next, the functional effect of divided packet, method of manufacturing the divided packet, and the device for manufacturing the divided packet related to above-mentioned embodiment are explained.

According to the divided packet 10 related to the embodiment, the packaging body 2 sealed with the swallowing aid substance 1 and the drug 3, are sealed by a commonly used divided bag 4. Hence, a divided packet 10 that can aid in swallowing the drug 3 by a simple method without using the special form of administering item accommodating chamber can be offered. The swallowing aid substance 1 is sealed by the packaging body 2, and the packaging body 2 is sealed by the divided bag 4. Hence, the deterioration of the swallowing aid substance 1 can be effectively controlled.

According to the packaging body 10 related to the embodiment, the packaging body 2 is constructed to enable the flow of the swallowing aid substance 1, from the inside of packaging body 2, to the inside of the divided bag 4 and external to the packaging body 2, by an external pressure. As a result, the swallowing aid substance 1 can be introduced inside the divided bag 4, and mixed with the drug 3 by a simple method.

According to the divided packet 10 related to this embodiment, the packaging body 2 contains the first seal S1 heat sealed with an overlapped film. The swallowing aid substance 1 is constructed to enable the flow from the inside of the packaging body 2 by destroying the first seal S1, to the inside of the divided bag 4 and external to the packaging body 2. The load when introducing the swallowing aid substance 1 inside the divided bag 4 can be adjusted by forming the first seal S1.

According to the divided packet 10 related to this embodiment, the packaging body 2 also includes a second seal S2 which is set in the direction opposite to the direction where the swallowing aid substance 1 is provided with respect to the first seal S1, and has higher seal strength than the first seal S1. The second seal S2 is set so as to separate the flow when the swallowing aid substance 1 flows from the inside of the packaging body 2, to the inside of the divided bag 4 and external to the packaging body 2. The swallowing aid substance 1 can be smashed to the size that is easy to swallow, because the swallowing aid substance 1 can be smashed using the second seal S2.

According to the method of manufacturing divided packet 10 related to this embodiment, the packaging body 2 sealed with the swallowing aid substance 1 and the drug 3 is sealed by the divided bag 4. As a result, a divided packet that can aid in swallowing the drug 3 by a simple method, without using the special form of administering item accommodating chamber, can be manufactured. The swallowing aid substance 1 is sealed by the packaging body 2, and the packaging body 2 is sealed by the divided bag 4. Hence, the divided packet 10 that can effectively control deterioration of the swallowing aid substance 1 can be manufactured.

According to the method of manufacturing divided packet 10 related to this embodiment, the process of preparing the divided bag 4 provided with the packaging body 2 and drug 3 includes, the process of preparing the divided bag 4 sealed with the drug 3, the process of unsealing the divided bag 4, and the process of providing the packaging body 2 sealed with the swallowing aid substance 1 inside the unsealed divided bag 4. As a result, the divided packet that can aid in swallowing the drug 3, by unsealing the divided bag 4 sealed with the drug 3, and by providing the packaging body 2 sealed with the swallowing aid substance 1 inside the unsealed divided bag 4 can be manufactured.

According to the manufacturing device 100 of the divided packet 10 of this embodiment, the packaging body inserter 105 is constructed to enable the provision of packaging body 2 sealed with the swallowing aid substance 1, inside the divided bag 4 that has the opening. As a result, a manufacturing device 100 that can manufacture the divided packet 10 to aid in swallowing the drug 3 by a simple method, without using the special form of administering item accommodating chamber can be provided. The swallowing aid substance 1 is sealed by the packaging body 2, and the packaging body 2 is sealed by the divided bag 4. Hence, a manufacturing device 100 that can manufacture the divided packet 10 that can effectively control deterioration of the swallowing aid substance 1 can be provided.

According to the manufacturing device 100 of the divided packet 10 of this embodiment, it is further provided with the divided bag unsealer 104 that is constructed to enable the unsealing of divided bag 4 sealed with the drug 3. A manufacturing device 100 that can manufacture the divided packet to aid in swallowing the drug 3, by unsealing the divided bag 4 sealed with the drug 3, and by providing the packaging body 2 sealed with the swallowing aid substance 1 inside the unsealed divided bag 4 can be provided.

### Working Example

In this working example, the relation between the space of the two adjoining second seals S2 in the packaging body 2, and the load F to destroy the first seal S1 of packaging body 2 was examined.

First, fourteen types of packaging bodies 2 (Refer to FIG. 1) sealed with the swallowing aid substance 1 explained in embodiment 1 were manufactured. The packaging body 2 has the first seal S1 and multiple second seals S2. The space of the adjoining second seal S2 in the packaging body 2 (slit width) was assumed as 6 mm, 7 mm, 8 mm, 9 mm, 10 mm, 11 mm, 12 mm, 13 mm, 14 mm, 15 mm, 16 mm, 17 mm, 18 mm, and 19 mm.

The load F was applied from the exterior for each of the packaging bodies 2 of the above-mentioned fourteen types, and the load F necessary to destroy the first seal S1 of the packaging body 2 by increasing the concerned load F was measured.

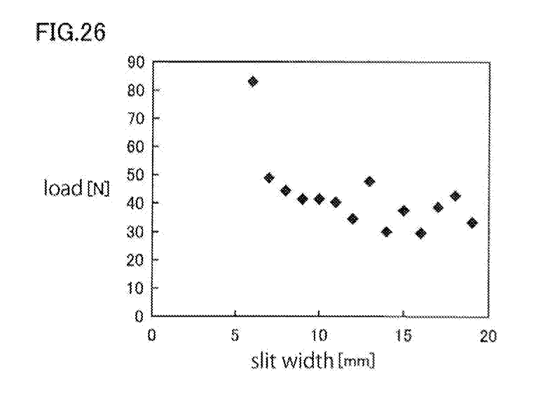

With reference to FIG. 26, the relation between the slit width and the load F necessary to destroy the first seal S1 of the packaging body 2 is explained. As shown in FIG. 26, when the slit width was 6 mm, the load F to destroy the first seal S1 was 83.1N. When the slit width was 7 mm, the load F to destroy the first seal S1 was 48.9N. When the slit width was ≧8 mm and ≦19 mm, the load F to destroy the first seal S1 was ≦50N. In short, it was confirmed that the load to destroy the first seal S1 when the slit width was ≧7 mm became remarkably small, when compared with the case of 6 mm slit width. In other words, the first seal S1 can be destroyed with a small load, by making the slit width to ≧7 mm.

The embodiment disclosed this time should be considered as an exemplification in all aspects, and not a limiting item. The scope of this invention is shown not by the above-mentioned explanation but by the scope of the claim, and equivalent meaning to the scope of the claim, and all changes within the scope are intended to be included.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

While the invention has been particularly shown and described with respect to preferred embodiments thereof, it should be understood by those skilled in the art that the foregoing and other changes in form and detail may be made therein without departing from the sprit and scope of the invention as defined in the appended claims.

### EXPLANATION OF REFERENCES

1, 1a, 1b Swallowing aid substance, 2 Packaging body, 2a Film, 3 Drug, 4 Divided bag, 4a Medicine wrapping paper (First medicine wrapping paper), 4b Second medicine wrapping paper, 4c Mixing chamber, 4d, 6 Opening, 5 Portion-to-be-unsealed, 7 Fold position, 10 Divided packet, 100 Manufacturing device, 101 Divided bag insert, 102 Height adjuster, 103 Cutoff line printer, 104 Divided bag unsealer, 105 Packaging body inserter, 105a First packaging body inserter, 105b Second packaging body inserter, 105c Third packaging body inserter, 106 Adsorption pad, 107 Divided bag sealer, 108 Motor, 109 Divided bag collector, 110 Feed belt, S1 First sealer, S2 Second seal, S3 Third seal, S4 Fourth seal, S5 Fifth seal, S6 Sixth seal, S7 Seventh seal, S11 First weak seal, S12 Second weak seal, x Space, y Distance.

What is claimed is:

1. A divided packet, provided with the packaging body sealed with the jelly that is the swallowing aid substance, the drug disposed on the exterior of the said packaging body, divided bag which seals in the said drug and the said packaging body sealed with the said jelly;
the said packaging body and the said drug are sealed by the said divided bag;
the said packaging body contains the first seal that is heat sealed with the overlapped film and extended in one direction, and the second seal that is set on the side opposite to the direction where the said jelly is disposed with respect to the said first seal and has higher seal strength than the said first seal;
the said jelly is constructed to enable the flow, from the inside of the said packaging body by destroying the said first seal, to the inside of the said divided bag and external to said packaging body;
the said second seals are set in multiple numbers, so as to separate the flow when the said jelly flows from the inside of the said packaging body, to the inside of the said divided bag and external to the said packaging body, to have the distance between the said first seal along the vertical direction where the said first seal is extended, and the size along direction where the said first seal is extended is smaller than the size of the said first seal, and to keep the space and adjoin along the direction where the said first seal is extended;
the said multiple second seals are constructed to enable the smashing by passing the jelly that flows from the inside of the said packaging body between the adjoining two second seals, when an external pressure is applied to the said jelly.

2. The divided packet as defined in claim 1, wherein the said packaging body is constructed to enable the flow of the said jelly from the inside of said packaging body, to the inside of the said divided bag and external to said packaging body, by an external pressure.

3. A method of manufacturing the divided packet, provided by the process to arrange the divided bag that has the opening and provided with the drug and packaging body sealed with the jelly that is the swallowing aid substance in the inside, and by the process to seal the said drug and the said packaging body sealed with the said jelly by the said divided bag;
the said packaging body contains the first seal that is heat sealed with the overlapped film and extended in one direction, and the second seal that is set on the side opposite to the direction where the said jelly is disposed with respect to the said first seal and has higher seal strength than the said first seal;
the said jelly is constructed to enable the flow, from the inside of the said packaging body by destroying the said first seal, to the inside of the said divided bag and external to the said packaging body;
the said second seals are set in multiple numbers, so as to separate the flow when the said jelly flows from the inside of the said packaging body, to the inside of the said divided bag and external to the said packaging body, to have the distance between the said first seal along the vertical direction where the said first seal is extended, and the size along direction where the said first seal is extended is smaller than the size of the said first seal, and to keep the space and adjoin along the direction where the said first seal is extended;
the said multiple second seals are constructed to enable the smashing by passing the jelly that flows from the inside of the said packaging body between the adjoining two second seals, when an external pressure is applied to the said jelly.

4. The method of manufacturing the divided packet as defined in claim 3, wherein the process of arranging the said divided bag provided with the said packaging body and the said drug in the inside, includes the process of preparing the said divided bag sealed with the said drug, the process of unsealing the said divided bag, and the process of providing the said packaging body sealed with the said jelly inside the unsealed said divided bag.

5. A device for manufacturing the divided packet, is provided with the packaging body inserter constructed to enable the provision of packaging body sealed with the jelly that is the swallowing aid substance, inside the divided bag that has the opening, and with the divided bag sealer constructed to enable the sealing of the said divided bag by closing the said opening of the said divided bag provided inside the drug and the said packaging body sealed with the said jelly;
the said packaging body contains the first seal that is heat sealed with the overlapped film and extended in one direction, and the second seal that is set on the side opposite to the direction where the said jelly is disposed with respect to the said first seal and has higher seal strength than the said first seal;
the said jelly is constructed to enable the flow, from the inside of the said packaging body by destroying the said first seal, to the inside of the said divided bag and external to the said packaging body;
the said second seals are set in multiple numbers, so as to separate the flow when the said jelly flows from the inside of the said packaging body, to the inside of the said divided bag and external to the said packaging body, to have the distance between the said first seal along the vertical direction where the said first seal is extended, and the size along direction where the said first seal is extended is smaller than the size of the said first seal, and to keep the space and adjoin along the direction where the said first seal is extended;
the said multiple second seals are constructed to enable the smashing by passing the jelly that flows from the inside of the said packaging body between the adjoining two second seals, when an external pressure is applied to the said jelly.

6. The device for manufacturing the divided packet as defined in claim 5, wherein it is further provided with the divided bag unsealer that is constructed to enable the unsealing of the said divided bag sealed with the said drug
